(19) United States
(12) Patent Application Publication
(10) Pub. No.: US 2007/0068567 A1
(43) Pub. Date: Mar. 29, 2007

(54) Testing apparatus and method for solar cells

(76) Inventors: Leonid B. Rubin, Burnaby (CA); Alexander S. Osipov, Burnaby (CA); Valery M. Nebusov, Burnaby (CA); Vasili Y. Tarasenko, Burnaby (CA); Andreas Schneider, Burnaby (CA)

Correspondence Address: KNOBBE MARTENS OLSON & BEAR LLP, 2040 MAIN STREET, FOURTEENTH FLOOR, IRVINE, CA, 92614, US

(21) Appl. No.: 11/234,828

(22) Filed: Sep. 23, 2005

(51) Int. Cl. H02N 6/00

(52) U.S. Cl. 136/243; 136/290

(57) ABSTRACT

A method for temporarily electrically coupling to each of a plurality of current gathering fingers on a surface of a solar cell, to facilitate testing of the solar cell involves pressing a flexible elongate electrical conductor onto the surface of the solar cell such that an elongate contact surface of the electrical conductor extends across the surface of the solar cell to make electrical contact with substantially all of a surface of a bus connected to the fingers or at least a portion of each of the fingers, or both.

### BACKGROUND OF THE INVENTION

1. Field of Invention

This invention relates to solar cell test equipment and methods and more particularly to methods and apparatuses for testing solar cells with or without bus bars.

2. Description of Related Art

It is well-known that under light illumination photovoltaic (PV) solar cells generate electric current that is collected from the cell by front and rear electrical contacts. The front contact typically comprises a plurality of thin screen printed lines known as “fingers”, all connected to each other by two thicker screen-printed lines referred to as “bus bars” or “terminal bars”. The fingers collect electrical current from the PV cell itself and the bus bars receive the current from the fingers and transfer it away from the cell.

Each screen printed finger has a width of approximately 120 microns, a height of between 5 and 20 microns and the spacing between the fingers is typically 1.5 to 3 mm. Technical limitations imposed by screen printing technology further introduce ±1 to 10 micron variances in finger height and a ±10 to 30 micron or greater variance in width.

A rear side electrical contact normally covers the entire rear surface of the solar cell with screen printed metallic material such as aluminum paste, except for a few small areas of silver containing screen printed paste to form what are referred to as “silver pads”. When producing PV modules manufacturers interconnect large numbers of PV cells in series by soldering tinned copper ribbons attached to the bus bars on the front of one cell to the silver pads on the back of an adjacent next cell.

Each solar cell has its own individual electrical characteristics and therefore in manufacturing, all solar cells must be tested and selected in order to achieve maximum module efficiency. Such testing is well-known and commonly performed in a machine known as a solar cell tester. Such testers are manufactured by several companies and are readily available from the following sources, for example, (Berger Lichttechnik GmbH & Co. KG, Isarstrasse 2 D-82065 Baierbrunn, Germany Tel.: +49(0)89/793 55 266 E-mail: info@bergerlichttechnik.de; BELVAL SA Sous-la-Roche, PO Box 5 CH-2042 Valangin, Switzerland, Tel.: +41 32 857 23 93 Fax:+41 32 857 22 95 Email info@belval.com; H.A.L.M. Elektronik GmbH Sandweg 30-32 D-60316 Frankfurt am Main, Germany, Tel.: 069-943 353.0).

A conventional tester comprises several parts, including a pulse light source for sun-light simulation, an electric contacting frame and an electronic measuring unit. The contacting frame performs several functions including: (a) creation of reliable low resistive electrical contacts with bus-bars on front side and silver pads (or other material) on the rear side of a solar cell under test, (b) collect electric current from the solar cell; and (c) measure values of I-V characteristics including short circuit current (Isc), open circuit voltage (Voc), fill-factor (FF), and maximum power output (Pmax).

The contacting frame includes current collecting components including upper and lower solid metallic (usually brass) plates. These plates hold a plurality of gold-plated measuring tips, separated from each other by about 10-20 mm. Each measuring tip comprises a housing, a circular contacting head having a diameter of about 1-3 mm and a pressure equalizing spring located between the housing and the contacting head. The circular contacting head generally has a sharp edge.

When the contacting frame is mechanically pressed onto the surface of the solar cell, the sharp edges of the contacting heads on the front of the solar cell are inserted into the bus bars while contacting heads on the rear are inserted into corresponding locations in the silver pads on the rear side of the cell, to equalize pressure applied on opposite sides of the solar cell. The solar cell is then exposed to solar radiation and electric current is collected from the front of the solar cell by the screen printed fingers and is received at the bus bars on the solar cell. Current is then collected from the bus bars by the measuring tips and is finally passed to a front side solid metallic plate to which measurement circuitry is connected. A rear side of the solar cell has a metallic layer with silver pads thereon which are contacted by a similar contact lead arrangement and rear side solid metallic plate which is also connected to the measurement circuitry to complete a measurement circuit comprising the solar cell. The use of the plurality of contact heads on the bus bars and silver pads provides a low resistance contact that provides accurate electrical characteristics of the solar cell. Alternative contacting approaches are known using for example, a Four Testing Probe, but generally these alternative approaches employ similar contacting frames and tips.

The above described solar cell testing equipment is currently widely used in industry for conventional screen printed PV cell testing however it cannot be used to test conventional front contact silicon crystalline solar cells that have isolated screen printed fingers without bus-bars. This type of solar cell has several advantages including substantially higher efficiency than that of existing cells with bus-bars, due to reduced shading of the front surface due to the absence of the bus bars. In addition, this new type of cell eliminates the need to provide silver pads on the rear of the solar cell which leads to better BSF properties and increases in short circuit current (Isc) and open voltage (Voc). See, for example, Leonid B. Rubin, George L. Rubin, Ralf Leutz, “One-Axis PV Sun Concentrator Based on Linear Nonimaging Fresnel Lens”, International Conference on Solar Concentrators for the Generation of Electricity or Hydrogen, May 1-5, 2005, Scottsdale, Ariz., USA).

It is not practical to use the plurality of contact heads to contact isolated screen printed fingers because the diameter of individual contacting tip heads is greater than the finger width and inevitably the sharp edges of the contact heads will contact the cell surface and penetrate the front of the cell, thereby damaging the p-n junction under its surface. Smaller contacting tip heads are also problematic because it is practically impossible to maintain a precise shape, spacing and positioning of fingers during screen printing.

In addition, solar cells are typically sold under a certain dollars per watt output formula, and thus manufacturers need to know the total power output of any given solar cell to determine the price of the cell. Existing technologies for determining total power output of conventional solar cells are well known, as exemplified by the solar cell testing equipment described above. Clearly this equipment cannot be used in its current form to test the newer type of isolated finger solar cells, because existing test equipment requires the solar cell have built-in bus bars, whereas isolated finger-type solar cells do not have bus bars. Thus, there is a need for test equipment that will test isolated finger solar cells, and even more desirably, both isolated finger solar cells and bus bar type solar cells.

The present invention addresses this need.

### SUMMARY OF THE INVENTION

In accordance with one aspect of the invention, there is provided a method for temporarily electrically coupling to each of a plurality of current gathering fingers on a surface of a solar cell, to facilitate testing of the solar cell. The method involves pressing a flexible elongate electrical conductor onto the surface of the solar cell such that an elongate contact surface of the electrical conductor extends across the surface of the solar cell to make electrical contact with substantially all of a surface of a bus bar connected to the fingers or at least a portion of each of the fingers, or both.

The method may further involve equalizing pressure imposed by the electrical conductor across the surface of the solar cell. Equalizing pressure may involve resiliently deforming a resilient holder to which the electrical conductor is attached. Resiliently deforming may involve squeezing the electrical conductor between the resilient holder and the surface until the resilient holder is deformed. Squeezing may involve squeezing the electrical conductor with sufficient force to cause the electrical conductor to generally conform to a surface contour of the solar cell surface.

Pressing may involve moving toward the solar cell surface a mount to which the resilient holder is attached.

Pressing may involve temporarily pressing the electrical conductor onto the surface of the solar cell.

In accordance with another aspect of the invention, there is provided a method of testing a solar cell having a plurality of electrically isolated current gathering fingers. The method involves holding the solar cell in a contacting station of a solar cell tester and pressing a flexible elongate electrical conductor onto the surface of the solar cell such that an elongate contact surface of the electrical conductor extends across the surface of the solar cell to make electrical contact with substantially all of a surface of a bus bar connected to the fingers or at least a portion of each of the fingers, or both.

The method may further comprise mounting the electrical conductor to the contacting station.

Mounting the electrical connector to the contacting station may involve mounting to the contacting station a mount holding a resilient holder to which the electrical conductor is attached.

Pressing may involve causing the solar cell tester to permit the mount to move toward the surface of the solar cell such that sufficient force is applied to the mount to cause the electrical conductor to make contact with substantially all of a surface of the bus bar or at least a portion of each of the fingers, or both.

The method may further involve exposing the solar cell to light to cause the solar cell to produce and pass electric current to the fingers and gathering at the electrical conductor the electric current collected by the fingers to facilitate measurement of electric current collected by the fingers by the solar cell tester.

In accordance with another aspect of the invention, there is provided a method for temporarily electrically coupling to each of a plurality of isolated current gathering fingers on a surface of a solar cell, to facilitate testing of the solar cell. The method involves pressing a flexible elongate electrical conductor onto the surface of the solar cell such that an elongate contact surface of the electrical conductor extends across the surface of the solar cell and contacts at least a portion of all of the fingers.

In accordance with another aspect of the invention, there is provided a method for temporarily electrically coupling to a bus bar on a surface of a solar cell, where the bus bar is connected to each of a plurality of current gathering fingers on the surface of the solar cell, to facilitate testing of the solar cell. The method involves pressing a flexible elongate electrical conductor onto the surface of the solar cell such that an elongate contact surface of the electrical conductor extends across the surface of the solar cell and contacts substantially all of a surface of the bus bar.

In accordance with another aspect of the invention, there is provided an apparatus for testing a solar cell having a plurality of current gathering fingers on a surface thereof. The apparatus includes a flexible elongate electrical conductor having an elongate contact surface operable to be pressed onto the surface of the solar cell and to extend across the surface of the solar cell to make electrical contact with substantially all of a surface of a bus bar connected to the fingers or at least a portion of each of the fingers, or both. The electrical conductor is operable to be electrically connected to a solar cell tester. The apparatus further includes a pressure equalizer for equalizing pressure applied by the electrical conductor across the surface of the solar cell.

The pressure equalizer may include provisions for pressing the electrical conductor against the surface such that the electrical conductor extends generally perpendicularly to the fingers, across the surface of the solar cell to gather electric current produced by the solar cell for detection by the solar cell tester.

The apparatus may further include a holder operably configured to hold the provisions for pressing. The holder may include a connector operably configured to connect the holder to a solar cell contacting station, such that the contacting station can manipulate the holder to position the apparatus for use in testing the solar cell.

The holder may be electrically conductive and the electrical conductor may be electrically connected to the holder such that the holder is operable to electrically connect the electrical conductor to the solar cell tester.

The electrical conductor may be sufficiently flexible to permit the electrical conductor to generally conform to a contour of the surface of the solar cell, when the electrical conductor is pressed against the surface.

The electrical conductor may include a flexible woven material and the woven material may include a material formed of woven electrically conductive strands. The electrically conductive strands may have a diameter in a range of about 20 to about 200 microns.

The electrical conductor may alternatively include a flexible conductive tape.

The apparatus may further include a resilient support for supporting the electrical conductor.

The resilient support may include an elongate resilient member having a generally outwardly facing surface, the electrical conductor being on the generally outwardly facing surface.

The elongate resilient member may include a tube formed of resilient material, the tube having a generally cylindrical outer surface, the electrical conductor having a contacting portion on the generally cylindrical outer surface.

The electrical conductor may include first and second opposite side portions, on opposite sides of the contacting portion and arranged to extend generally parallel to each other, generally radially away from the cylindrical outer surface.

The apparatus may further include a holder operably configured to hold the first and second opposite side portions to secure the electrical conductor and the resilient support to the holder.

The holder may be operable to be connected to the solar cell tester, such that a contacting station of the solar cell tester can manipulate the holder to position the apparatus relative to the solar cell for use in testing the solar cell.

The holder may be electrically conductive and the first and second opposite side portions of the electrical conductor may be electrically connected to the holder such that the holder is operable to electrically connect the electrical conductor to the solar cell tester.

The elongate resilient member may include silicone rubber having a generally rectangular cross section, a generally circular cross section or a generally annular cross section, for example.

The apparatus may further include a holder operably configured to hold the resilient support to secure the electrical conductor and the resilient support to the holder.

The apparatus may include a plurality of spaced apart springs extending between the holder and the resilient support.

One advantage of the apparatus and methods described herein is the possibility to modify existing solar cell contacting stations for testing isolated finger solar cells, as well as solar cells having an integral current collecting bus connected to the fingers simply by exchanging a conventional front side contacting frame with the apparatus described above. The rear side contacting frame may be kept without replacement. More particularly, the apparatus described above can be efficiently used to test a large variety of PV cell types including crystalline silicon cells and EFG cells with or without front side bus bars as well as back side contact cells and any other type of solar cells with non-buried fingers.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1 is a perspective view of a solar cell test system comprising a solar cell tester and a contacting station;

FIG. 2 is a fragmented isometric view of two apparatuses according to one embodiment of the invention shown positioned over a solar cell;

FIG. 3 is a detailed, fragmented side view of one of the apparatuses shown in FIG. 2;

FIG. 4 is an end view of the end portion shown in FIG. 3;

FIG. 5 is a fragmented isometric view of an alternate resilient member of the apparatus shown in FIG. 2;

FIG. 6 is a fragmented cross-sectional view of an end portion similar to that shown in FIG. 3, of an apparatus according to an alternative embodiment of the invention;

FIG. 7 is a perspective view of an apparatus according to a further alternative embodiment of the invention shown positioned over a solar cell;

FIG. 8 is a cross-sectional view taken along lines VIII-VIII of the apparatus shown in FIG. 7;

FIG. 9 is a perspective view of an apparatus according to an alternative embodiment of the invention;

FIG. 10 is a cross-sectional view of the apparatus shown in FIG. 9 taken along lines X-X of FIG. 9;

FIG. 11 is a simplified perspective view of a solar cell with isolated fingers being tested in the contact station shown in FIG. 1;

FIG. 12 is a simplified perspective view of a solar cell with bus bars being tested in the contact station shown in FIG. 1.

### DETAILED DESCRIPTION

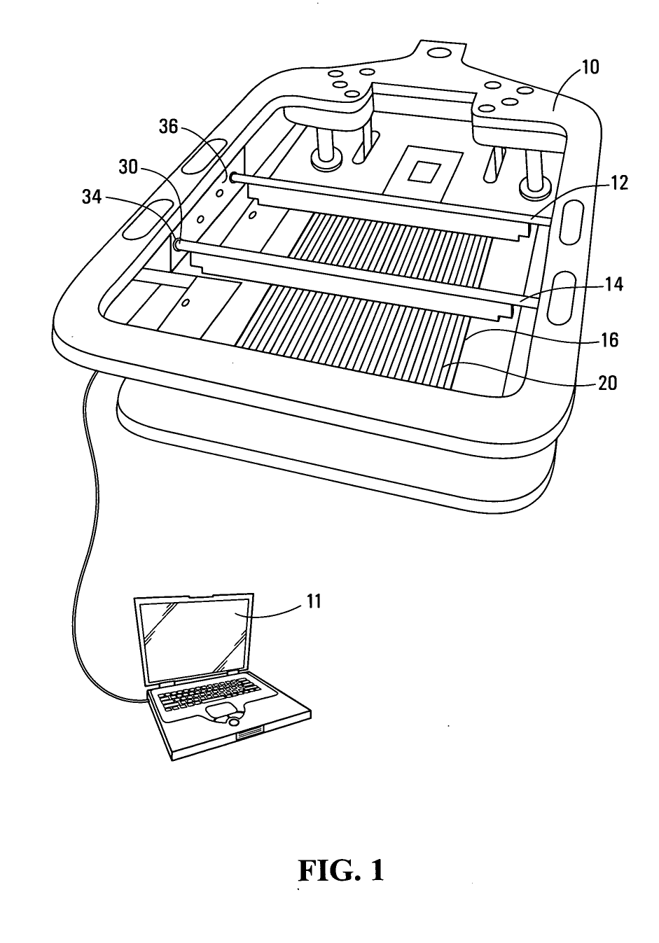

Referring to FIG. 1, a contacting station for solar cells is shown generally at 10. The contacting station 10 is, in this embodiment, a cetisPV-Contact1 contacting station for solar cells produced by H.A.L.M. Electronik GmbH, Sandweg 30-32, D-60316, Frankfurt am Main, of Germany and is connected to a solar cell test station 11. The contacting station 10 is conventional, with the exception of first and second apparatuses 12 and 14 that are specially designed for testing an isolated finger type solar cell 16 that does not employ integral bus bars for current gathering, but which are readily usable to alternatively test non-isolated finger type solar cells that do employ integral bus bars for current gathering.

The contacting station 10 is conventional and is normally intended for use in testing conventional solar cells that have a plurality of fingers that are electrically connected together by a bus bar permanently formed on the surface of the solar cell. The apparatuses 12 and 14 specifically permit the conventional contacting station 10 to be used to test isolated finger type solar cells as well as non-isolated finger type solar cells with bus bars, without changing the apparatuses 12 and 14.

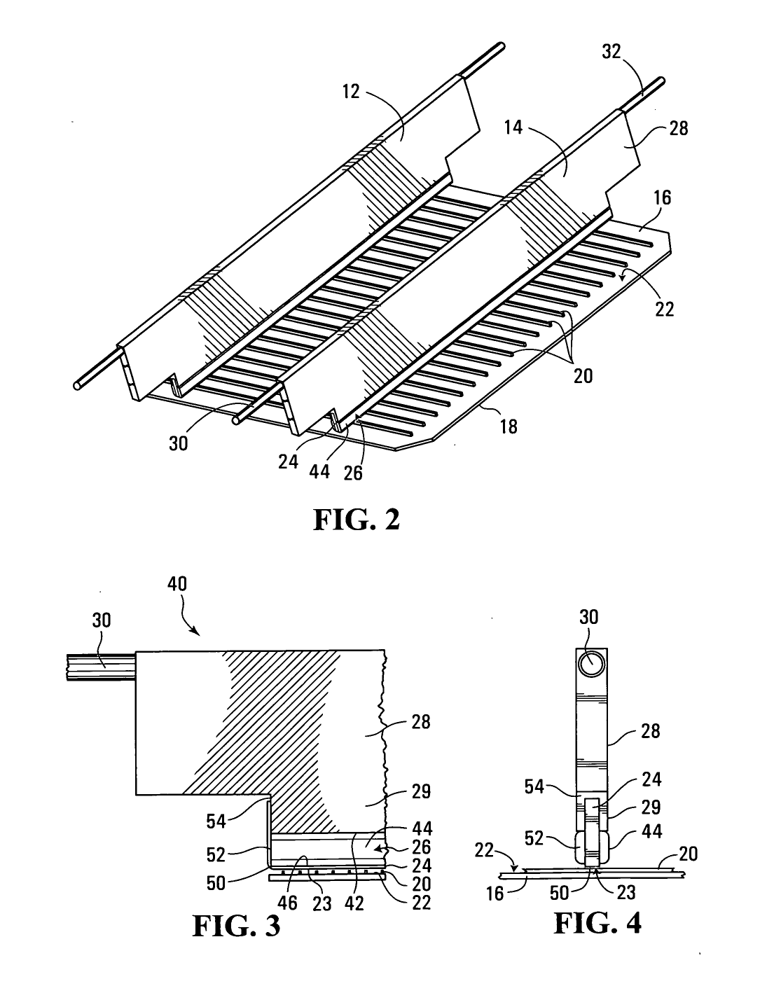

Referring to FIG. 2, an isolated finger type solar cell 16 is shown in greater detail. An isolated finger-type solar cell is comprised of a wafer 18 of silicon in which is formed a p-n junction. The p-n junction is connected to fingers 20 which are screen printed with conductive paste, onto a top surface 22 of the wafer 18 and hence the fingers are on a top surface of the solar cell 16. In this embodiment, the fingers 20 are parallel and spaced apart and have a width of approximately 120 microns. Each finger also has a height of between about 5 and about 20 microns. The fingers 20 are spaced apart by approximately 1.5 to approximately 3 mm. The fingers 20 are isolated in the sense that each finger is physically and electrically set apart from the others and is not connected to any other finger by an integral bus bar on the solar cell. The fingers 20 appear as a plurality of parallel spaced apart unconnected lines on the top surface 22 of the solar cell 16.

Still referring to FIG. 2, an apparatus 14 for testing a solar cell having a plurality of current gathering fingers on a surface thereof includes an elongate flexible electrical conductor 24 comprising a thin strip of electrically conductive film or tape operable to extend across the top surface 22 of the solar cell to simultaneously contact a portion of each of the fingers 20. In use, the flexible electrical conductor 24 is pressed against the top surface 22 of the solar cell 16 such that a contact surface 23 thereof makes a good, low resistance contact with a portion of each of the fingers 20. Such pressing may be achieved simply by allowing the apparatus 14 to lie under gravity across the surface 22 of the solar cell such that the flexible electrical conductor 24 rests on the surface 22 or by mechanically pressing the flexible electrical conductor onto the surface.

The apparatus 14 includes a pressure equalizer 26 for equalizing the pressure with which the flexible electrical conductor 24 is pressed against the top surface 22 and fingers 20 thereon. In this embodiment the pressure equalizer 26 includes a resilient support 44 which acts to press the flexible electrical conductor 24 against the surface 22 such that the flexible electrical conductor extends across the fingers and generally conforms to a contour of the surface of the solar cell and simultaneously contacts all of the fingers to facilitate gathering of electric current produced by the solar cell 16, for detection by the solar cell test station 11.

In this embodiment, the resilient support 44 is connected to a holder 28 which, in this embodiment, is formed of a brass plate having first and second connectors 30, 32 at opposite ends thereof, operable to be received in corresponding openings, only one of which is shown at 34, in a mounting member 36 of the contacting station 10 shown in FIG. 1. In this embodiment, the connectors 30 and 32 comprise metallic dowels connected to the brass plate.

Referring to FIG. 3, an end portion of the holder 28 is shown in more detail at 40. The holder 28 has a blade portion 29 having lower edge 42 to which, the resilient support 44 is connected. In this embodiment, the resilient support 44 is comprised of an elongated resilient member having a generally outwardly facing surface 46 that extends all along the lower edge 42, from one end of the holder 28 to the other. The flexible electrical conductor 24 is on the generally outwardly facing surface 46 and faces toward the fingers 20 of the solar cell 16 when the apparatus 14 is installed, as shown in FIG. 1, in the contacting station.

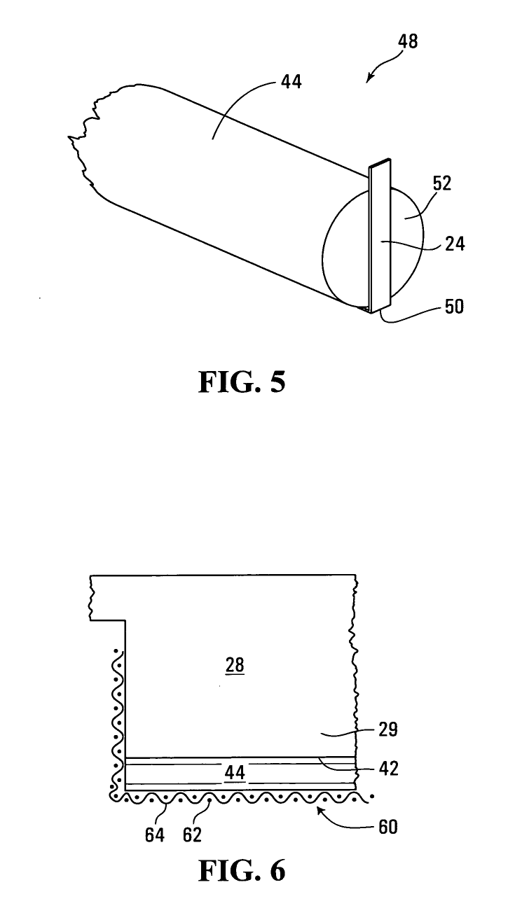

Referring to FIG. 4, in this embodiment, the resilient support 44 includes an elongated resilient member formed of silicone rubber having a generally rectangular cross section. Alternatively, however, the elongated resilient member may have a circular cross section such as shown at 48 in FIG. 5.

In the embodiments shown in FIGS. 3, 4 and 5, the flexible electrical conductor 24 is made longer than the resilient support 44 such that it can be bent upwardly at a right angle as shown generally at 50 in FIGS. 3, 4 and 5 to extend past an end portion 52 of the resilient support 44 and is electrically connected at its opposite ends to respective end faces, only one of which is shown at 54, of the blade portion 29. In this way, both ends of the flexible electrical conductor 24 are electrically connected to the holder 28.

Referring to FIG. 6, in an alternative embodiment, the flexible electrical conductor may include a flexible woven material such as shown generally at 60, formed of woven electrically conductive strands 62, 64, for example. The electrically conductive strands may be formed of gold, for example, and may have a diameter in a range of about 20 microns to about 200 microns.

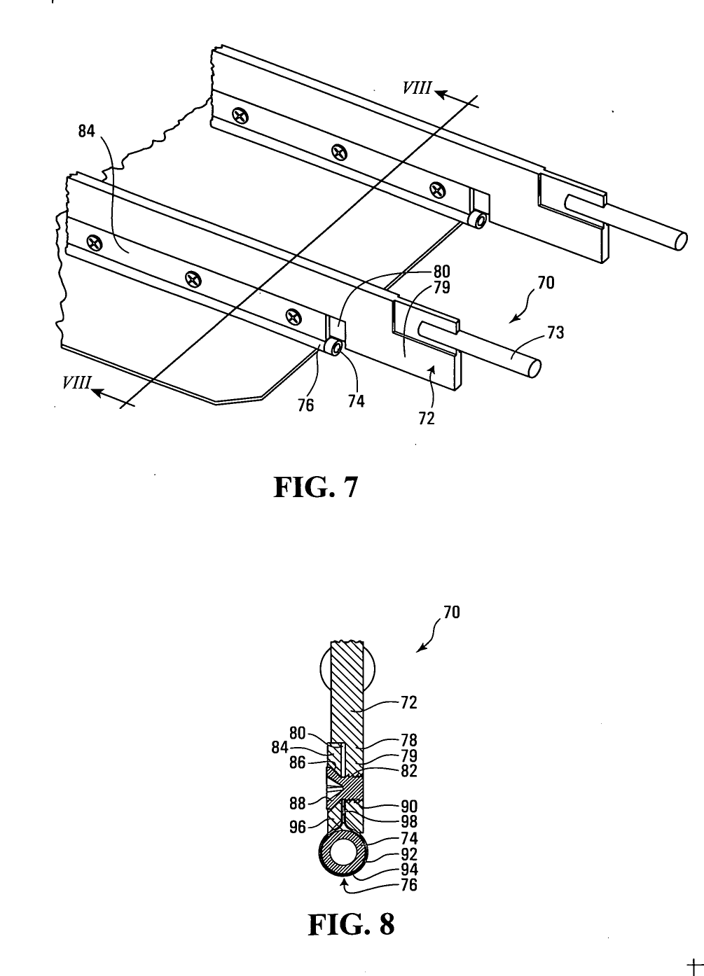

Referring to FIG. 7, an apparatus according to an alternative embodiment of the invention is shown generally at 70 and includes a holder 72, a resilient support 74 and a flexible electrical conductor 76. The holder 72 is comprised of a flat bar 78, having first and second connectors at opposite ends thereof, only one of which is shown at 73, and having a blade portion 79.

Referring to FIG. 8, the blade portion 79 has a generally rectangular recessed portion 80 with a threaded bore 82 extending through the blade portion 79 and having an opening in the recessed portion 80. A generally rectangular clamp member 84 is received in the recessed portion 80 and has an opening 86 that can be aligned with the threaded bore 82 in the blade portion 79. A screw 88 having a threaded shaft 90 is inserted through the opening 86 and is aligned with the threaded bore 82 in the blade portion 79 so as to engage the bore to draw the clamp member 84 toward the blade portion.

In this embodiment, the resilient support 74 is formed from an elongate tube of resilient material such as silicone rubber and has a generally cylindrical outer surface 92 and a generally annular cross section.

In this embodiment, the flexible electrical conductor 76 has a contacting portion 94 and first and second opposite side portions 96 and 98. The first and second opposite side portions 96 and 98 are arranged to extend generally parallel to each other and generally radially away from the cylindrical outer surface 92 of the resilient support 74. In this embodiment, the flexible electrical conductor 76 may be formed of a flexible conductive film or tape or the woven material described above in connection with FIGS. 3 and 6, for example. Generally, the contacting portion 94 of the flexible electrical conductor 76 encircles the generally cylindrical outer surface 92 of the resilient support 74 and the first and second opposite side portions 96 and 98 of the flexible electrical conductor are brought together to envelope the cylindrical outer surface 92 of the resilient support 74.

The first and second opposite side portions 96 and 98 of the flexible electrical conductor 76 are received between the clamp member 84 and the blade portion 79. The blade portion 79 and clamp member 84 act as a holder for holding the resilient support 74 to secure the flexible electrical conductor 76 and the resilient support to the holder 72. The blade portion 79 and clamp member 84 are both formed of brass and since the first and second opposite side portions 96 and 98 are clamped between the blade portion 79 and the clamp member 84, an electrical connection is made between the flexible electrical conductor 76 and the holder 72. When the connector 73 of the holder 72 is inserted into the opening 34 of the contacting station 10 shown in FIG. 1, the holder 72 is connected to the solar cell tester such that contacting station 10 can manipulate the holder to position the apparatus for use in testing a solar cell.

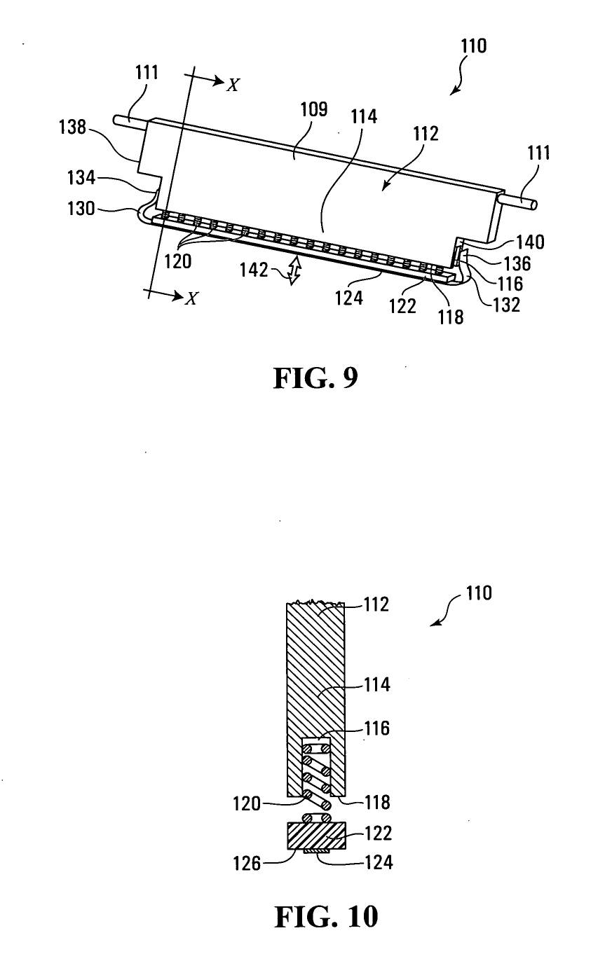

Referring to FIGS. 9 and 10, an apparatus according to yet another alternative embodiment is shown generally at 110 and includes a holder 112 having a plate 109, connectors 111 at opposite ends of the plate and a blade portion 114 with a recess 116 formed in a lower edge 118 thereof. A plurality of coil springs 120 are received in the recess 116 and are connected to a resiliently deformable insulating block 122. A flexible electrical conductor 124 is secured to a lower surface 126 of the block 122.

The holder 112 is similar to that shown in FIGS. 2 and 7 in that it extends across the solar cell 16 but differs in that it has the recess 116 or a plurality of separate recesses and springs that are connected all along the block 122 to which the flexible electrical conductor 124 is secured.

The flexible electrical conductor 124 is formed with loops 130 and 132 at opposite ends thereof and has terminating portions 134 and 136 that are electrically connected to edges 138 and 140 of the blade portion 114. The loops 130 and 132 permit the block 122 and flexible electrical conductor thereon to move up and down in the direction indicated by arrow 142 without stressing the connections between the terminating portions 134 and 136 with corresponding edges 138 and 140, while preserving the electrical connection between the ends of the flexible electrical conductor 124 and the edges 138 and 140.

Operation

In use, the apparatus shown in FIGS. 2 through 6, or the apparatus shown in FIGS. 7 and 8, or the apparatus shown in FIGS. 9 and 10 may be used as either or both of the apparatuses 12 and 14 in FIG. 1. Generally, to use any of these apparatuses, the connectors (30, 73, 111) on these apparatuses are placed in openings, only one of which is shown at 34, in the contacting station shown in FIG. 1. The contacting station may have an electrical contact (not shown) that automatically engages one of the connectors or a separate electrical connection may be made with the holder (28, 79, 112) to electrically connect the holder and hence the flexible electrical conductor (24, 76, 124) electrically connected thereto to the solar cell test station 11.

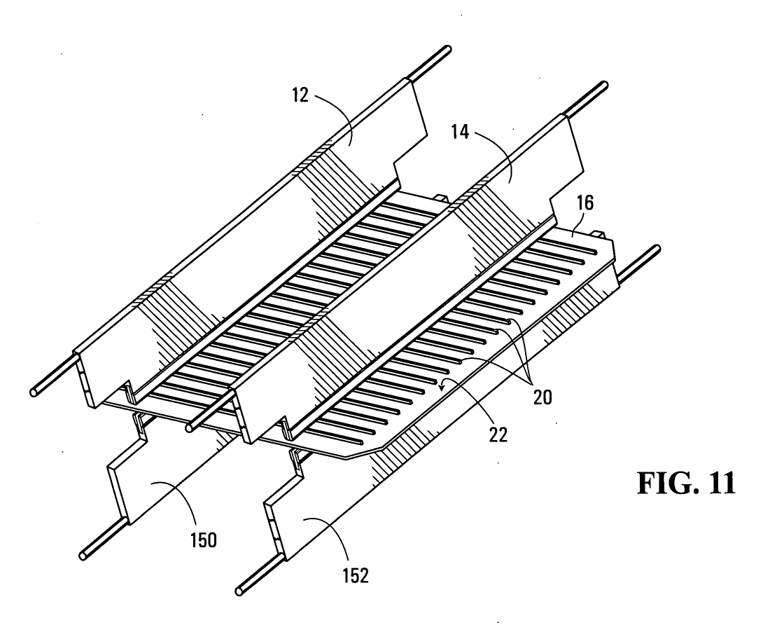

A solar cell 16 to be tested is placed in the contacting station 10 in the conventional manner and a plurality of contact heads (not shown) contact an underside of the solar cell and make an electrical connection therewith in a conventional manner. Alternatively, at least one of the apparatuses shown in FIGS. 2-6, 7-8 or 9-10 may be installed underneath the solar cell to make an electrical connection with the underside of the solar cell. For example, as shown in FIG. 11, the solar cell may rest on two of the apparatuses 150, 152 described above, wherein the apparatuses are oriented such that the flexible electrical conductors (24, 76, 124) thereof are facing upwardly to contact a rear surface of the solar cell 16.

In order to test electrical current output of the solar cell 16, the flexible electrical conductor (24, 76, 124) on the apparatus 14 is pressed against the top surface 22 of the solar cell 16 such that the flexible electrical conductor (24, 76, 124) extends across the fingers 20 and contacts the fingers. Pressing may be achieved by causing the mounting members 36 on each side of the contact station (10 shown in FIG. 1) to be lowered mechanically or manually by gravity or by actuators on the contact station 10 onto the top surface 22 of the solar cell 16. Desirably, the apparatus 14, hereinafter referred to as the upper apparatus, is directly over and aligned with a corresponding one of the apparatuses 150 supporting the solar cell, so that the solar cell 16 becomes squeezed between the upper apparatus 14 bearing on its upper surface and the lower apparatus 150 bearing on its rear surface such that the forces imposed by the upper and lower apparatuses are directly aligned. It is necessary to impose a sufficient squeezing force to ensure a good electrical connection between the fingers and the flexible electrical conductors.

Since the flexible electrical conductors (24, 76, 124) are elongate, they provide a relatively large surface area over which the squeezing force is applied by the upper and lower apparatuses to the top and rear surfaces of the solar cell 16. This large surface area distributes the squeezing forces and avoids damaging the top and rear surfaces of the solar cell, and in particular avoids damaging the fingers, while still achieving a good electrical connection between the flexible electrical conductors (24, 76, 124) and the fingers 20.

Generally pressing the flexible electrical conductor (24, 76, 124) across the fingers 20 involves causing the flexible electrical conductor to bear upon the resilient support (44, 74, 122) when a contact surface of the flexible electrical conductor is in contact with each of the fingers, such that the resilient support member presses the flexible electrical conductor against the surface 22 and more particularly, the fingers.

By pressing the flexible electrical conductor (24, 76, 124) against the top surface 22 of the solar cell 16, the flexible electrical conductor is pressed across the fingers 20 such that a contact surface of the flexible electrical conductor simultaneously contacts each of the fingers. This serves to temporarily electrically couple each of the fingers 20 to each other and facilitates gathering electric current therefrom, by the flexible electrical conductor (24, 76, 124), when the solar cell is exposed to light. The flexible electrical conductor is flexible enough to conform to the contour of the surface of the solar cell to ensure a good low-resistance connection with the fingers.

The solar cell 16 is then exposed to light and the flexible electrical conductor (24, 76, 124) gathers from the fingers 20 electric current produced by the solar cell 16. This electric current can then be used by the solar cell test station 11 to determine the electrical characteristics of the solar cell 16.

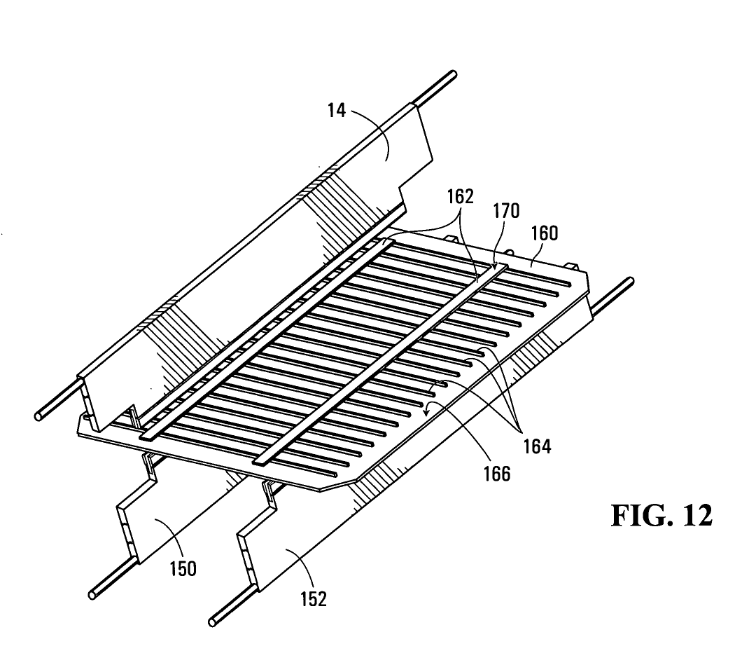

Referring to FIG. 12, the apparatus 14 described above can also be used in testing a conventional solar cell 160 having a bus bar 162 and fingers 164 on a top surface 166 thereof. In such use, the solar cell 160 and the apparatus 14 can be aligned such that the flexible electrical conductor (24, 76, 124) of the upper apparatus 14 is operable to be pressed onto the surface 166 of the solar cell and to extend across the surface of the solar cell to make electrical contact with substantially all of a surface 170 of the bus bar 162. The flexible electrical conductor (24, 76, 124) is flexible enough to conform to the contour of the surface of the solar cell 160, in particular the bus bar 162, to ensure a good low-resistance connection therewith.

Thus the apparatuses described herein can be used for testing both isolated finger-type solar cells and bus bar-type solar cells.

While specific embodiments of the invention have been described and illustrated, such embodiments should be considered illustrative of the invention only and not as limiting the invention as construed in accordance with the accompanying claims.

What is claimed is:

1. A method for temporarily electrically coupling to each of a plurality of current gathering fingers on a surface of a solar cell, to facilitate testing of the solar cell, the method comprising:
pressing a flexible elongate electrical conductor onto the surface of the solar cell such that an elongate contact surface of the electrical conductor extends across the surface of the solar cell to make electrical contact with substantially all of a surface of a bus bar connected to said fingers or at least a portion of each of said fingers, or both.

2. The method of claim 1 further comprising equalizing pressure imposed by said electrical conductor across the surface of the solar cell.

3. The method of claim 1 wherein equalizing pressure comprises resiliently deforming a resilient holder to which said electrical conductor is attached.

4. The method of claim 3 wherein resiliently deforming comprises squeezing said electrical conductor between said resilient holder and said surface until said resilient holder is deformed.

5. The method of claim 4 wherein squeezing comprises squeezing said electrical conductor with sufficient force to cause said electrical conductor to generally conform to a surface contour of said solar cell surface.

6. The method of claim 5 wherein pressing comprises moving toward the solar cell surface a mount to which said resilient holder is attached.

7. The method of claim 1 wherein pressing comprises temporarily pressing said electrical conductor onto the surface of the solar cell.

8. A method of testing a solar cell having a plurality of electrically isolated current gathering fingers, the method comprising the method of claim 1 and further comprising holding the solar cell in a contacting station of a solar cell tester.

9. The method of claim 8 further comprising mounting the electrical conductor to the contacting station.

10. The method of claim 9 wherein mounting the electrical connector to the contacting station comprises mounting to said contacting station a mount holding a resilient holder to which said electrical conductor is attached.

11. The method of claim 10 wherein pressing comprises causing the solar cell tester to permit said mount to move toward the surface of the solar cell such that sufficient force is applied to said mount to cause said electrical conductor to make contact with substantially all of a surface of a bus connected to said fingers or at least a portion of each of said fingers, or both.

12. The method of claim 11 further comprising:
exposing the solar cell to light to cause the solar cell to produce and pass electric current to the fingers; and
gathering at said electrical conductor said electric current collected by the fingers to facilitate measurement of electric current collected by the fingers by the solar cell tester.

13. An apparatus for testing a solar cell having a plurality of current gathering fingers on a surface thereof, the apparatus comprising:
a flexible elongate electrical conductor having an elongate contact surface operable to be pressed onto the surface of the solar cell and to extend across the surface of the solar cell to make electrical contact with substantially all of a surface of a bus bar connected to said fingers or at least a portion of each of said fingers, or both;
and wherein said electrical conductor is operable to be electrically connected to a solar cell tester; and
a pressure equalizer for equalizing pressure applied by the electrical conductor across the surface of the solar cell.

14. The apparatus of claim 13 wherein said pressure equalizer comprises means for pressing said electrical conductor against said surface such that said electrical conductor extends generally perpendicularly to said fingers, across said surface of the solar cell to gather electric current produced by the solar cell for detection by the solar cell tester.

15. The apparatus of claim 14 further comprising a holder operably configured to hold said means for pressing, said holder comprising a connector operably configured to connect said holder to a solar cell contacting station, such that said contacting station can manipulate said holder to position said apparatus for use in testing the solar cell.

16. The apparatus of claim 15 wherein said holder is electrically conductive and wherein said electrical conductor is electrically connected to said holder such that said holder is operable to electrically connect said electrical conductor to said solar cell tester.

17. The apparatus of claim 13 wherein said electrical conductor is sufficiently flexible to permit said electrical conductor to generally conform to a contour of the surface of the solar cell, when said electrical conductor is pressed against the surface.

18. The apparatus of claim 13 wherein said electrical conductor comprises a flexible woven material.

19. The apparatus of claim 18 wherein said woven material comprises a material formed of woven electrically conductive strands.

20. The apparatus of claim 19 wherein said electrically conductive strands have a diameter in a range of about 20 to about 200 microns.

21. The apparatus of claim 13 wherein said electrical conductor comprises a flexible conductive tape.

22. The apparatus of claim 13 further comprising a resilient support for supporting said electrical conductor.

23. The apparatus of claim 22 wherein said resilient support comprises an elongate resilient member having a generally outwardly facing surface, said electrical conductor being on said generally outwardly facing surface.

24. The apparatus of claim 23 wherein said elongate resilient member comprises a tube formed of resilient material, said tube having a generally cylindrical outer surface, said electrical conductor having a contacting portion on said generally cylindrical outer surface.

25. The apparatus of claim 24 wherein said electrical conductor comprises first and second opposite side portions, on opposite sides of said contacting portion and arranged to extend generally parallel to each other, generally radially away from said cylindrical outer surface.

26. The apparatus of claim 25 further comprising a holder operably configured to hold said first and second opposite side portions to secure said electrical conductor and said resilient support to said holder.

27. The apparatus of claim 26 wherein said holder is operable to be connected to the solar cell tester, such that a contacting station of the solar cell tester can manipulate said holder to position said apparatus relative to the solar cell for use in testing the solar cell.

28. The apparatus of claim 27 wherein said holder is electrically conductive and wherein said first and second opposite side portions of said electrical conductor are electrically connected to said holder such that said holder is operable to electrically connect said electrical conductor to the solar cell tester.

29. The apparatus of claim 23 wherein said elongate resilient member comprises silicone rubber having a generally rectangular cross section.

30. The apparatus of claim 23 wherein said elongate resilient member comprises silicone rubber having a generally circular cross section.

31. The apparatus of claim 23 wherein said elongate resilient member comprises silicone rubber having a generally annular cross section.

32. The apparatus of claim 22 further comprising a holder operably configured to hold said resilient support to secure said electrical conductor and said resilient support to said holder.

33. The apparatus of claim 32 wherein said holder is operable to be connected to the solar cell tester, such that a contacting station of the solar cell tester can manipulate said holder to position said apparatus relative to the solar cell for use in testing the solar cell.

34. The apparatus of claim 33 wherein said holder is electrically conductive and wherein said electrical conductor is electrically connected to said holder such that said holder is operable to electrically connect said electrical conductor to said solar cell tester.

35. The apparatus of claim 34 further comprising a plurality of spaced apart springs extending between said holder and said resilient support.

36. A method for temporarily electrically coupling to each of a plurality of isolated current gathering fingers on a surface of a solar cell, to facilitate testing of the solar cell, the method comprising:
pressing a flexible elongate electrical conductor onto the surface of the solar cell such that an elongate contact surface of the electrical conductor extends across the surface of the solar cell and contacts at least a portion of all of said fingers.

37. A method for temporarily electrically coupling to a bus on a surface of a solar cell, where the bus is connected to each of a plurality of current gathering fingers on the surface of the solar cell, to facilitate testing of the solar cell, the method comprising:
pressing a flexible elongate electrical conductor onto the surface of the solar cell such that an elongate contact surface of the electrical conductor extends across the surface of the solar cell and contacts substantially all of a surface of the bus.
